(19) United States
(12) Patent Application Publication
(10) Pub. No.: US 2025/0115347 A1
(43) Pub. Date: Apr. 10, 2025

(54) AIRCRAFT WING COMPRISING A STORAGE TANK FOR GASEOUS HYDROGEN

(71) Applicant: ROLLS-ROYCE plc, London (GB)

(72) Inventors: Chloe J. PALMER, Derby (GB); Malcolm L HILLEL, Derby (GB); Daniel CLARK, Derby (GB)

(73) Assignee: ROLLS-ROYCE plc, London (GB)

(21) Appl. No.: 18/729,431

(22) PCT Filed: Jan. 4, 2023
(86) PCT No.: PCT/EP2023/050105

§ 371 Date: Jul. 16, 2024

(30) Foreign Application Priority Data
Feb. 4, 2022 (GB) 2201430.2

(51) Int. Cl. B64D 37/04; B64D 37/30; F17C 1/16

(52) U.S. Cl. CPC B64D 37/04; B64D 37/30; F17C 1/16; F17C 2201/0152; F17C 2205/013; F17C 2221/012; F17C 2223/036; F17C 2270/0189

(57) ABSTRACT

A storage tank for gaseous hydrogen includes a continuous tank wall defining a serial array of hollow elongate tank portions of substantially constant cross-section and hollow connecting portions defining an internal storage volume, wherein adjacent ends of any pair of adjacent hollow elongate tank portions are connected by a hollow connecting portion having a cross-sectional dimension smaller than those of the adjacent hollow elongate tanks portions. The tank may be included in an aircraft wing such that it extends spanwise through one or more internal spars of the wing, thus providing a continuous gas storage volume at a given chordwise position notwithstanding the spars, and providing for storage of gaseous hydrogen at higher gravimetric efficiency than is achievable by a plurality of coupled discrete tanks disposed between the spars.

### CROSS-REFERENCE TO RELATED APPLICATIONS

This application is based upon and claims the benefit of priority from United Kingdom Patent Application GB 2201430.2, filed on Feb. 4, 2022, the entire contents of which are hereby incorporated by reference.

### BACKGROUND OF THE INVENTION

### Field of the Invention

The invention relates to an aircraft wing comprising a storage tank for gaseous hydrogen.

### Description of Related Art

Storage of gaseous hydrogen with high gravimetric efficiency is a key technical objective in the development of hydrogen-powered aircraft. Propulsion of such aircraft may be based on use of polymer electrolyte (proton exchange) (PEM) fuel cells and/or hydrogen-burning gas turbine engines. High gravimetric efficiency depends on lightweight tanks which are able to store gaseous hydrogen at high pressure, for example several hundred bar or more. Conventional, high-pressure gas storage tanks are typically either cylindrical with hemispherical ends, or spherical in order to avoid high asymmetric stresses in the tank walls. A storage arrangement for gaseous hydrogen preferably involves a small number of individual tanks because, in an arrangement in which several tanks are coupled together, hydrogen tends to effuse through threads, welds, and other joining locations, as a result of the very small size of hydrogen molecules. Furthermore, the presence of hemispherical or otherwise domed ends of individual storage tanks contributes significantly to the total weight of a storage arrangement, compromising its gravitational efficiency. In a conventional aircraft, at least some of the aircraft's fuel tanks are located in the wings of the aircraft. The presence of mechanical supporting structure within an aircraft wing tends to result in a significant number of individual tanks coupled together to form a storage arrangement. In the case of kerosene storage this is not problematic, however in the case of hydrogen storage, this results in significant hydrogen leakage and compromises the overall gravimetric efficiency with which gaseous hydrogen may be stored. Furthermore, connecting individual tanks in a linear array extending spanwise, as is the case in conventional wing fuel storage, creates high bending moments in connections between tanks when a wing flexes. This can result in fatigue in the connections, which is particularly problematic in the case of hydrogen storage as it can increase fuel leakage.

Published international application WO 02/39010 discloses a pressure vessel for storage of pressurised fluids. The vessel comprises a plurality of hollow chambers, each having a substantially spherical or ellipsoidal shape, a plurality of relatively narrow conduit sections, each positioned between adjacent hollow chambers to interconnect the hollow chambers, and a reinforcing filament wrapped around the hollow chambers and conduit sections.

U.S. Pat. No. 10,851,925 discloses a liner for a compressed gas storage vessel, the liner having two cylindrical tubing portions, connected by two taper portions and a cuff portion of lower diameters than the diameter of the tubing portions.

Published patent application CN 106628114 discloses a wing for a drone, the wing comprising a plurality of spars and a plurality of cylindrical fuel storage tanks for storing compressed gaseous hydrogen and oxygen, the fuel tanks passing through the spars.

### BRIEF SUMMARY

The invention provides an aircraft wing comprising a plurality of spars each being located at a respective spanwise position and extending substantially chordwise and having a respective aperture therein, characterised in that the aircraft wing further comprises a first storage tank for gaseous hydrogen, the first storage tank comprising a continuous tank wall defining a serial array of hollow elongate tank portions of substantially constant cross section and hollow connecting portions defining a storage volume, adjacent ends of any pair of adjacent hollow elongate tank portions being connected by a hollow connecting portion having a cross-sectional dimension smaller than those of the adjacent hollow elongate tank portions, the storage tank passing through the aperture of each spar such that each hollow connecting portion of the storage tank coincides with an aperture in a respective spar. Preferred embodiments are defined in the dependent claims.

### BRIEF DESCRIPTION OF THE SEVERAL VIEWS OF THE DRAWINGS

Embodiments of the invention are described below by way of example only and with reference to the accompanying drawings in which:

FIGS. 1 & 2 show first and second example storage tanks for storing gaseous hydrogen;

FIGS. 3, 4 & 5 show first, second and third example aircraft wings;

FIG. 6 shows a portion of third example storage tank; and

FIG. 7 shows a fourth example storage tank.

### DETAILED DESCRIPTION

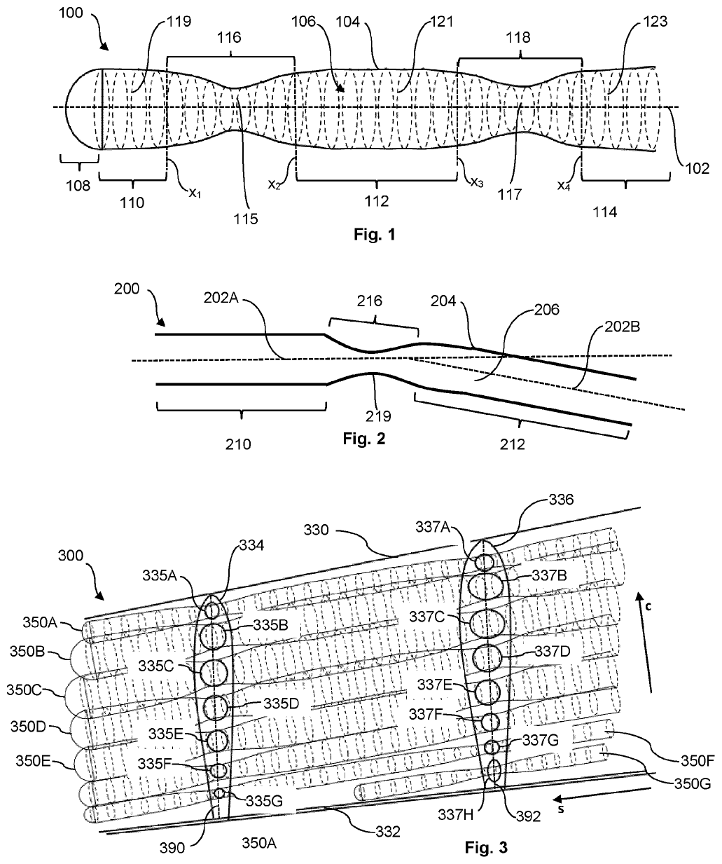

Referring to FIG. 1, an organic composite storage tank 100 for storing gaseous hydrogen at high pressure (i.e. several hundred bar) has a single continuous organic composite wall 104 defining a three substantially hollow cylindrical elongate tank portions 110, 112, 114 of equal diameter and having a common central longitudinal axis 102, and two hollow connecting portions 116, 118 which are axisymmetric with respect to the axis 102. Cross-sections 119, 121, 123 of the tank 100 are substantially the same. The tank 100 has a single continuous internal storage volume 106. Adjacent ends of hollow cylindrical elongate tank portions 110, 112 at axial positions x₁, x₂ are connected by the hollow connecting portion 116 which has an average diameter less than the diameter of the hollow cylindrical elongate tank portions 110, 112. At axial positions x₁, x₂ the diameter of the hollow connecting portion 116 is equal to that of the hollow cylindrical elongate tank portions 110, 112. Between axial positions x₁, x₂ the diameter of the hollow connecting portion 116 passes through a minimum value, resulting in a neck or constriction 115.

Similarly, adjacent ends of hollow cylindrical elongate tank portions 112, 114 at axial positions x₃, x₄ are connected by a hollow connecting portion 118. The diameter of the hollow connecting portion 118 is equal to that of the hollow cylindrical elongate portions 112, 114 at axial positions x₃, x₄ and passes through a minimum value between these axial positions, forming a constriction 117.

The continuous tank wall 104 also forms a hemispherical end portion 108; a similar end portion (not shown) terminates the tank 100 at an end thereof remote from the end portion 108. In variants of the tank 100, there may be four, or more, hollow cylindrical elongate portions, adjacent ends of a given pair of adjacent hollow cylindrical elongate portions being connected by a hollow connecting portion. The continuous tank wall 104 is formed of an organic composite material, or an organic composite laminate material.

A variant of the tank 100 has a continuous tank wall made of a metal or metal alloy, rather than an organic composite material.

Referring to FIG. 2, a second example tank 200 comprises a continuous organic composite tank wall 204 which defines hollow elongate cylindrical tank portions 210, 212 having mutually-inclined longitudinal axes 202A, 202B respectively, and a connecting portion 216. Adjacent ends of the portions 210, 212 are connected by a hollow connecting portion 216. The diameter of the hollow connecting portion 216 is equal to that of the portions 210, 212 where the portions 210, 212 meet the hollow connecting portion 216 and passes through a minimum value between these positions, producing a constriction 219. The tank 200 comprises further hollow elongate cylindrical tank portions (not shown) extending away from the tank portions 210, 212 and coupled by further connecting portions. Two terminal hollow elongate cylindrical tank portions are each closed by a hemispherical or domed end portion (not shown) of the continuous tank wall 204.

Referring to FIG. 3, an example aircraft wing 300 comprises a wing body having leading and trailing edges 330, 332 respectively and internal spars 334, 336. Spanwise and chordwise directions are indicated by unit vectors s and c respectively in FIG. 3. The aircraft wing comprises two internal spars 334, 336 which provide internal supporting structure as is required in larger commercial aircraft for example. The spars 334, 336 have respective sets of apertures 335A-335G, 337A-337H respectively in order to reduce the weight of the spars 334, 336. The aircraft wing 300 further comprises hydrogen storage tanks 350A-G, each being of the type described above with reference to FIG. 1, and each being linear and located at a respective chordwise position. Each hollow connecting portion of a given tank 350A-G coincides with an aperture of a respective spar substantially at the position of its neck or constriction. For example, tank 350A has two connecting portions which pass through apertures 335A, 337A in spars 334, 336 respectively; the locations of the minimum diameters of the hollow connecting portions substantially coincide with the apertures 335A, 337A. Each of the tanks 350A-G thus has a single continuous internal storage volume which extends without interruption along the full spanwise extent of the wing 300 shown in FIG. 3. This avoids the need for a series of discrete cylindrical tanks, each having hemispherical or domed ends, located between spars which compromises the overall gravimetric efficiency of a tank system of which the tanks form part. Furthermore, tanks such as 350A-G allow some flexing of the wing 300 without producing leakage or damage to the tanks 350A-G, and are more resilient to this problem than linear arrays of discrete cylindrical tanks joined by rigid couplings.

The spars 334, 336 are divided along lines 390, 392 respectively, substantially in the plane of the wing 300. Lines 390, 392 each bisect the apertures of the corresponding spar 334, 336 so that the spars may each be separated into two parts to allow their removal from the tanks 350A-G and allowing one or more tanks to be replaced if required. In addition, the wing 300 may be assembled around the tanks 350A-G.

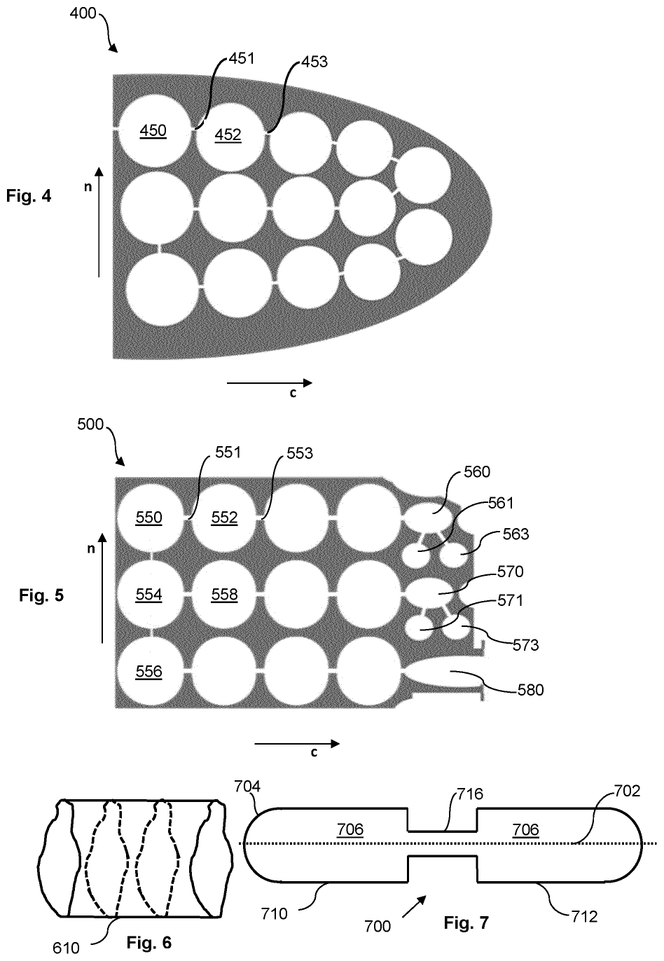

Referring to FIG. 4, a portion of a second example aircraft wing is indicated generally by 400. The spanwise direction s of the wing 400 is normal to the plane of FIG. 4. The chordwise direction is indicated by c. n indicates the direction c×s. (c, s, and n are unit vectors). The aircraft wing 400 comprises a plurality of hydrogen storage tanks such as 450, 452, distributed in the cn plane, the internal storage volumes of the tanks being coupled together to form an array of tanks having their internal storage volumes coupled together. Each tank has a general form as shown in FIG. 1 and extends along the spanwise direction s of the wing 400 at a respective position in the cn plane. The tanks comprised in the wing 400 form an assembly of tanks which extends in the direction n, in contrast to the aircraft wing 300 of FIG. 3 in which the tanks 350A-G are substantially confined to a plane (i.e. the plane of FIG. 3). The aircraft wing 400 comprises a plurality of internal spars (not shown) each located at a respective spanwise position and extending in the directions c and n. The hollow connecting portions of a given tank each pass through an aperture in a respective spar, the apertures having substantially the same cn position as the given tank.

FIG. 5 shows a portion of a third example aircraft wing, indicated generally by 500. The aircraft wing 500 comprises a plurality of hydrogen storage tanks such as 550, 552, 554, each extending spanwise within the wing 500 at a respective position in the cn plane and having the general form of the tank 100 of FIG. 1, except for tanks 560, 570, 580 which have hollow elongate tank portions of generally elliptical cross-section. The aircraft wing 500 further comprises internal spars each located at a respective spanwise position. The hollow connecting portions of a given tank each pass through an aperture in a respective spar, the apertures having the substantially the same position in the cn plane as the given tank.

In contrast to the tanks of the aircraft wing 400 of FIG. 4, the internal storage volumes are not simply connected in series but define bifurcated paths. For example, the internal storage volume of tank 554 is connected to the internal storage volumes of 550, 556 and 558. The internal storage volume of tank 560 is connected to those of tanks 561, 563. The internal storage volume of tank 570 is connected to those of tanks 571, 573.

FIG. 6 shows a hollow elongate portion 610 of a third hydrogen storage tank, the hollow elongate portion having a constant but irregular and non-circular cross section.

FIG. 7 shows a fourth hydrogen storage tank 700, the tank 700 comprising two elongate hollow cylindrical tank portions 710, 712 connected by a hollow cylindrical connecting portion 716 having a constant diameter which is smaller than that of the tank portions 710, 712. The tanks portions 710, 712 are each terminated by a respective hemispherical or domed end portion. The tank 700 has a continuous tank wall 704 and an internal storage volume 706.

In the tanks 100, 200, 700, the diameter of a tank varies with axial position because the diameters of the hollow connecting portions 116, 118, 219, 716 of a tank are less than those of the hollow elongate portions 110, 112, 114, 210, 212, 710, 712 of the tank. Since hoop stress reduces with diameter for a given pressure, at positions where the diameter reduces (i.e. at connecting portions 116, 118, 216, 716), the thickness of the continuous tank walls 104, 204, 704 may also be reduced, thus reducing the weight of the tanks 100, 200, 700. The thickness of a continuous tank wall 104, 204, 704 at a given axial position may be a decreasing function of the cross-sectional dimension or diameter of the tank at that axial position, for example a continuously decreasing function of cross-sectional dimension or diameter.

As shown in FIGS. 1 and 2, the hollow elongate tank portions 110, 112, 114 and 210, 212 of tanks 100, 200 respectively each have a length with respect to axes 102 and 202A, 202B respectively which is substantially greater than their cross-sectional dimensions. For example, in the case of hollow cylindrical tank portion 112 of the tank 100 in FIG. 1, the aspect ratio of length to diameter is about 2:1. For portion 210 of the tank 200 of FIG. 2, the aspect ratio of length to diameter is about 3.5:1. The aspect ratio for hollow elongate tank portions of the tanks 350A-E in FIG. 3 may be between about 2:1 and about 50:1 or greater than 50:1. The same considerations apply to the tank portion 610 of FIG. 6 and the tank portions 710, 712 of the tank 700 of FIG. 7. In a tank of the invention, adjacent ends of a pair of hollow elongate tank portions are connected by a hollow connecting portion, the adjacent ends each being an end of a respective hollow elongate portion with respect to the length dimension of the hollow elongate tank portion.

What is claimed is:

1-9. (canceled)

10. An aircraft wing comprising a plurality of spars each being located at a respective spanwise position and extending substantially chordwise and having a respective aperture therein, wherein the aircraft wing further comprises a first storage tank for gaseous hydrogen, the first storage tank comprising a continuous tank wall defining a serial array of hollow elongate tank portions of substantially constant cross section and hollow connecting portions defining a storage volume, adjacent ends of any pair of adjacent hollow elongate tank portions being connected by a hollow connecting portion having a cross-sectional dimension smaller than those of the adjacent hollow elongate tank portions, the storage tank passing through the aperture of each spar such that each hollow connecting portion of the storage tank coincides with an aperture in a respective spar.

11. An aircraft wing according to claim 10 wherein the apertures are each located at a first chordwise position and form a first set of apertures, and wherein the storage tank is linear and extends spanwise.

12. An aircraft wing according to claim 11 wherein each spar has a respective second aperture located at a second chordwise position, and wherein the wing comprises a second storage tank like to the first, the second storage tank being linear and extending spanwise substantially parallel to the first storage tank and passing through each second aperture such that each hollow connecting portion of the second storage tank coincides with a second aperture of a respective spar.

13. An aircraft wing according to claim 12 wherein each spar is divided in a plane substantially parallel to the plane of the wing, the plane bisecting the apertures of a corresponding spar.

14. An aircraft wing according to claim 11 and further comprising a plurality of storage tanks each like to the first tank, each tank of the plurality of tanks being linear, extending spanwise within the wing and being distributed in a direction normal to the plane of the wing.

15. An aircraft wing according to claim 14 wherein the storage volumes of the tanks are connected in series.

16. An aircraft wing according to claim 14 wherein the storage volume of the tanks are connected such that at least one tank is connected two or more serial arrays of tanks.

17. An aircraft wing according to claim 11 wherein the hollow elongate tank portions of the first tank are substantially cylindrical.

18. An aircraft wing according to claim 17 wherein any given hollow connecting portion of the first tank has a diameter which varies with axial position such that its diameter equals those of the hollow elongate tank portions it connects at the axial positions of the adjacent end thereof and passes through a minimum value between said positions.

19. An aircraft wing according to claim 17 wherein a terminal hollow elongate tank portion of the serial array of hollow elongate tank portions of the first tank has a domed or hemispherical end.

20. An aircraft wing according to claim 17 wherein the wall thickness of the first tank at a given axial position is a decreasing function of the cross-sectional dimension or diameter of the tank at that axial position.

21. An aircraft wing according to claim 17 wherein the first tank is fabricated from one of an organic composite material, an organic composite laminate material, a metal and a metal alloy.
